(19) United States
(12) Patent Application Publication
(10) Pub. No.: US 2007/0006415 A1
(43) Pub. Date: Jan. 11, 2007

(54) Apparatus and method for safely applying paint medium on a substrate

(76) Inventor: Paul Carson Plyler, Oceanside, CA (US)

Correspondence Address: PAUL CARSON PLYLER, 1624 KURTZ ST, OCEANSIDE, CA, 92054, US

(21) Appl. No.: 11/482,687

(22) Filed: Jul. 7, 2006

Related U.S. Application Data
(60) Provisional application No. 60/697,500, filed on Jul. 8, 2005.

(51) Int. Cl. B05C 17/00

(52) U.S. Cl. 15/244.1; 15/209.1

(57) ABSTRACT

Apparatus and method for safely applying art medium with an applicator with multiple benefits, a handle having a distal end and a proximal end, a tip attached to the handle using a hand operated clip attached to the distal end, a metal band attached to the distal end to prevent splitting, a tip that simulates the shape and texture of the human finger, and a tip whose shape produces a wide variety of effects, a tip that eleminates the need to blend the art medium with the fingers, a tip that is disposable, a tip that does not require stringent cleaning as present art brushes, an art tool that will produce good results for handicapped mouth and foot painting artists; and will be easier to use.

### CROSS REFERENCE TO RELATED APPLICATIONS

This application is based on provisional application serial number 60/697/500, filed on Jul. 08, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

### FIELD OF INVENTION

This invention relates generally to the field of devices for paint medium application and manipulation of paint by artists. The present invention relates to applicators and manipulators having a tip of soft foam with paint contacting surface which design simulates the shape, texture, and duplication of effects produced by the human finger, as opposed to traditional brushes having a bristle tip and other paint applicators and manipulators made from harder substances such as steel, rubber, silicone, etc. The present invention also relates to a method of attaching the soft foam tips to a handle to form a painting device that safely applies paint medium to artwork without contact with the skin.

History of Technology

Since the beginning of time artists have applied their paint medium by various means. They have used sticks, feathers, fingers, hands and other means. As time progressed and painting became a more refined, precise work, the use of bristle brushes became the tool and method of choice for most artists. Bristle brushes have since been used with a high degree of success and quality of work. Bristle brushes have usually been formed by attaching the hair bristles to a handle formed of wood. The types of brushes now available are: red sable, ox, goat, squirrel, camel, natural bristle, synthetic hair, and synthetic bristle. These brushes evolved over time into various sizes and shapes to produce a variety of strokes and effects.

Today there are many choices for artists to select from the type of brush that will meet their needs and produce the type of work that they choose to do. It would take an extended period of training or a prolonged period of trial and error to know which brush to choose to achieve the desired results they wish to produce. Some of the many choices are: round, round stroke, spotter, liner, ultra round, mid-length liner, shader flat, chisel blender “bright angular shader”, wash, one stroke “flat”, Filbert “oval”, fan, stippler, dome round, mop, stencil, and chipbrush. It is obvious that the choices of types of bristle and the size and shape of the known types can be most difficult to the uninitiated.

The need to clean the brushes so they can be used to apply different colors is a very time consuming process. Some types of painting are required to be done quickly to capture a rapidly changing element of subject matter. Continual thorough cleaning considerably slows this process. The only other choice an artist would have would be to have a multiple selection of all of the brushes most often used, which would be a costly additional burden to any artist.

### PRIOR TECHNOLOGY

There have been alternatives to bristle brushes produced to manipulate paint medium in various ways as shown in U.S. Pat. No. 2,861,371 to Leshik discloses types of steel spatulas. U.S. Pat. Nos. 2,099,030 and 2,147,310 to Morrison discloses types of rubber spatulas for paint manipulation.

U.S. Pat. No. 3,609,051 to Braun discloses a rotatable brush having a rotatable tip made of a porous resilient material, similar to that of conventional paint rollers.

U.S. Pat. No. 6,608,371 B1 to Forsline discloses a silicone paint brush artist's tool. This tool includes a handle and a painting tip made of a resilient silicone. This tool is designed to blend and move the paint medium much like a “squeegee”.

### DEFICIENCY IN PRIOR TECHNOLOGY

The tools previously mentioned in prior technology which includes steel spatulas, rubber spatulas, rotatable brushes, and silicone tipped paint brushes have the benefit of easy cleaning and a variety of shapes but produces a limited range of marks or effects. The previously mentioned tools are still not as effective as the bristle brushes currently used to produce most marks and effects in producing artwork. Even after all these tools are used to varying degree's to produce artwork, artists still use their fingers to create the soft, shaded, blended areas such as clouds, mist, water, etc. The fingers have been proven through time to be the best instrument to produce these special effects, and this method is mentioned in numerous art instructional material and courses of study.

However, contact with hazardous painting medium and absorption through the skin has caused numerous, even life-threatening health concerns. With these many considerations, it would be desireable to produce an artist' tool that would reproduce exactly those most desirable characteristics of the effects produced by the human finger. That is easy to clean, can be used multiple times, eliminates contact with hazardous toxic materials, and is disposable with a lower impact on the enviornment than conventional methods.

### BRIEF SUMMARY OF THE INVENTION

The primary object of the invention is To provide an Art Tool that safely applies painting medium.

Another object of the invention is To provide an Art Tool that eleminates the need to use fingers to blend the paint medium.

Another object of the invention is To provide an Art Tool that eleminates the absorption of toxic materials through the skin.

A further object of the invention is To provide an Art Tool that is disposable without having to come in contact with hazardous materials.

Yet another object of the invention is To provide an Art Tool that has a lower impact on the enviornment than other similar methods.

Still yet another object of the invention is To provide an Art Tool that has tips that can be cleaned and used multiple times.

Another object of the invention is To provide an Art Tool that produces results that are unequaled by other similar means.

Another object of the invention is To provide an Art Tool that is more versitile.

A further object of the invention is To provide an Art Tool that is less awkward to use and handle.

Yet another object of the invention is To provide an Art Tool that is simple and easy to make and use.

Other objects and advantages of the present invention will become apparent from the following descriptions, taken in connection with the accompanying drawings, wherein, by way of illustration and example, an embodiment of the present invention is disclosed.

### SUMMARY

In accordance with a preferred embodiment of the invention, there is disclosed apparatus and method for safely applying art medium comprising: an applicator with multiple benefits, a handle having a distal end and a proximal end, a hand operated clip attached to the distal end, a metal band attached to the distal end, a tip that simulates the shape and texture of the human finger, and a tip whose shape produces a wide variety of effects.

In accordance with a preferred embodiment of the invention, there is disclosed a process for Apparatus and method for safely applying art medium comprising the steps of: an applicator with multiple benefits, a tip formed of soft pliable foam material, the tip having a paint contact surface that is a rounded bottom surface and a tapered upper surface, and a tip attached to the handle by means of said hand operated clip, a tip that simulates the shape and texture of the human finger, and a tip whose upper, lower, and end surfaces may be used to apply the paint medium, and a tip whose shape produces a wide variety of effects, a metal band attached to said handle to prevent the said handle from splitting.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DESCRIPTION OF FIGURES

FIG. 1 is a plan view of the paint application and manipulation apparatus;

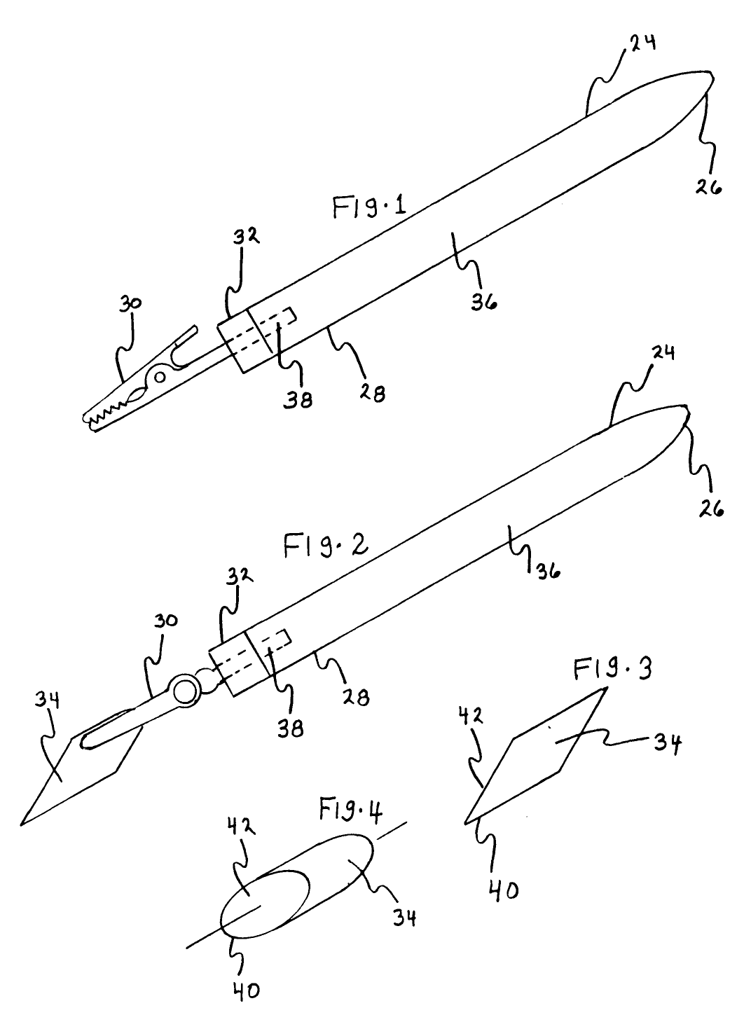

FIG. 2 is a side view of the apparatus of FIG. 1 with a paint medium manipulation tip installed;

FIG. 3 is a side view of the paint medium manipulation tip with its upper and lower paint manipulation surface;

FIG. 4 is a perspective view of the paint medium manipulation tip with its upper and lower paint manipulation surface;

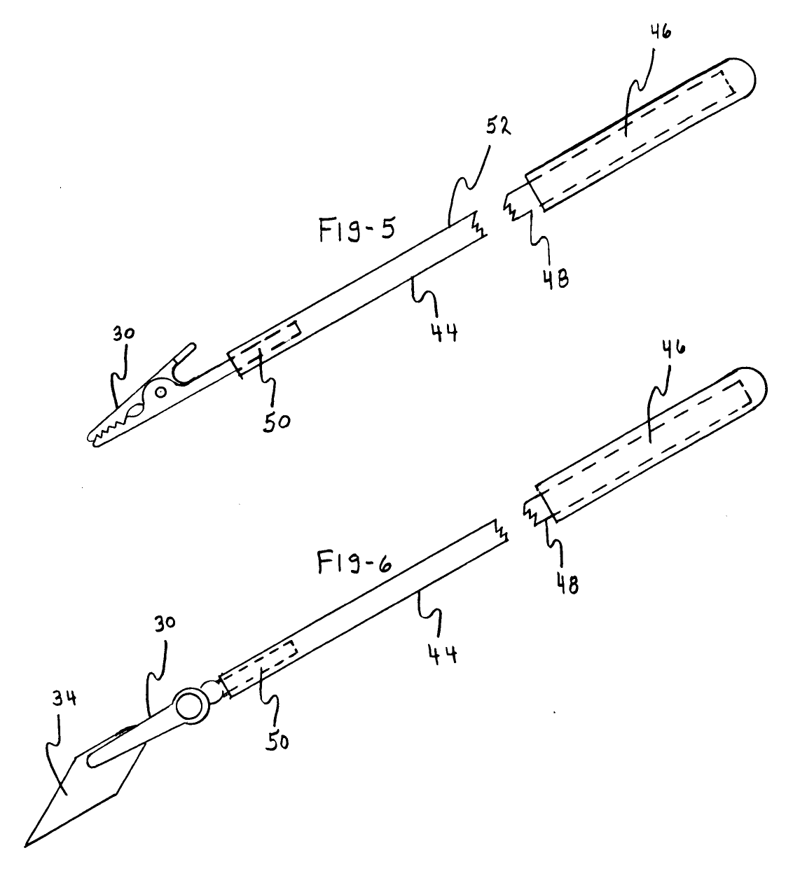

FIG. 5 is a plan view of the alternative embodiment;

FIG. 6 is a side view of the alternative embodiment shown in FIG. 5 with a paint medium manipulation tip installed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### Detailed Description of the Preferred Embodiments

Apperceptive knowledge of the said invention can be obtained in accordance with the drawings and a thorough examination of the following explanation. An overview of the preferred embodiments is provided. In addition to the overview, a detailed explanation of other alternative embodiments is also provided.

The said invention is a device for safely applying paint and to prevent contact with hazardous toxic substances in manipulating paint on artworks, which paint that is used may include but is not limited to oil paint, acrylic paint, and other paint substances with the same or similar viscosity. This device of invention comprising but not limited to providing the same benefits as traditional bristle brushes, is also easier to clean and provides multiple benefits.

As shown in FIG. 1, the said apparatus 24 having a handle 36 with a proximal end 26 and a distal end 28. The handle may be formed of wood with hardwood the primary choice finished with shellac, enamel, varnish, or lacquer. The handle may alternatively be formed of metal or plastic.

Attached to the distal end 28 of the apparatus 24 is a hand operated clip 30. The clip 30 is rigid and in a preferred embodiment the material may be steel, brass, copper, or aluminum with all surfaces subject to corrosion being “nickle” plated. Hand operated clips 30 could also be formed of plastic. As shown in FIG. 1 & 2 the hand operated clip 30 is preferably attached to the distal end 28 of the handle 36 by insertion into a 3/16″ prepared orifice 38. This is a tight pressed fit and no other adhesives or retention methods are required. As shown in FIG. 1 & 2 the metal band is attached to the distal end 28 of the handle 36 by means of a tight pressed fit and no other adhesive or retention methods are required. This metal band 32 is tight and prevents the handle 36 from splitting with constant use.

A soft foam applicator tip 34 is firmly held by the hand operated clip 30 which includes jaws with extended ridges to firmly grip the soft foam applicator tip 34. The soft foam applicator tip 34 is comprised of various sizes: large, medium small, depending on the size and type of artwork being done.

The operation of the artists apparatus 24 produces results and simulates as closely as can be achieved those blended, shaded, faded, misty, etc. effects achieved by the human finger, while doing artwork. The qualities, texture, and characteristics of the soft foam applicator tip 34 contact surface in association with the rounded bottom 40 and taperd upper surface 42 allows the paint to be safely transferred from pallet or container to the artwork and through manipulation produces a wide variety of results. As much or as little of the paint medium can be transferred each time paint is applied to avhieve the desired effect. The applicator tip 34 is formed of non-absorbent closed cell polyethelene, forming tips 34 that are sufficiently pliable whose shape and texture simulate the shape and texture of the human finger. The tip 34 can be wiped clean with no cleaning solvent or thinners required, and can continue to be used with other colors substantially speeding the process of painting a quickly changing subject matter. The tip 34 is soft and subject to wear, but the applicator tip 34 can be trimmed with scissors to renew the leading edge to a firm applicator surface 40. These steps of renewal of the applicator tip 34 can be done multiple times until a new process reduces the amount of times that would be required to clean conventional bristle brushes and other paint medium applicators, thereby reducing the amount of solvents and thinners needed for cleaning purposes. This process would substantially lower the amount of solvents and thinners that would be needed and the resources and energy to produce them. There would also be less contaminated solvents and thinners to be disposed of, which would greatly benefit the enviornment.

The applicator tip 34 is formed of non-absorbernt closed cell polyethelene. A preferred source for this material is structural grade backer rod available from MD Specialty And Thermwell Products Co. Inc. This product is supplied and tips 34 are cut from a length of the material. The tips 34 may be formed by molding but would be expensive to produce. Those cut from a length of material are less expensive and are just as serviceable.

Although the connection of the hand operated clip 30 is attached to the handle 36 by means of a prepared orifice 38 and a pressed fit which is the preferred embodiment. This attachment may be provided in other ways, such as adhesives or other mechanical means.

In an alternative embodiment of the present invention and to assist the utilization of the said apparatus by the handicapped and the mouth and foot painting artists, the handle 44 as shown in FIG. 5 would have a proximal 48 and a distal 50 end and would be extended to a focal length to suit the individual, and could be cut to length. The handle 44 would be cut to length. The handle 44 would be made of aluminum or other lightweight material to reduce fatigue and stress during use of said invention. The handle 44 would be tubular and would have a 3/16 diameter inside dimension to receive the hand operated clip 30 by means of a pressed fit on the distal end. The proximal end 48 of said apparatus would be fitted with a tubular covering 46 composed of vinyl, rubber, silicone, or other soft but durable material to prevent the user from holding bare metal in the mouth. The highly desirable quality of the embodiment shown in FIG. 5 is that the handicapped artist will not have to clean their paint applicator device 52 as often and as thorough as with bristle brushes, whereas one apparatus 52 can be used to do a complete painting or artwork.

In summary, it can be determined that the present invention in its present and various embodiments produce a new and extremely useful artist tool, comprising a device and method heretofore not available in the art tool spectrum.

Because of the many deviations and modifications that can be made to this invention, the scope of the invention is not limited to a single embodiment illustrated or described. The scope of the invention is to be determined by the written references, descriptions, drawings, and claims and their equivalents.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Apparatus and method for safely applying art medium comprising:
an applicator with multiple benefits;
a handle having a distal end and a proximal end;
a hand operated clip attached to the distal end;
a metal band attached to the distal end;
a tip that simulates the shape and texture of the human finger. ; and
a tip whose shape produces a wide variety of effects.

2. A process for Apparatus and method for safely applying art medium comprising the steps of:
an applicator with multiple benefits;
a tip formed of soft pliable foam material, the tip having a paint contact surface that is a rounded bottom surface and a tapered upper surface; and
a tip attached to the handle by means of said hand operated clip;
a tip that simulates the shape and texture of the human finger. ; and
a tip whose upper, lower, and end surfaces may be used to apply the paint medium; and
a tip whose shape produces a wide variety of effects;
a metal band attached to said handle to prevent the said handle from splitting.
